(19) United States
(12) Patent Application Publication
(10) Pub. No.: US 2026/0352513 A1
(43) Pub. Date: Nov. 5, 2026

(54) MULTI-FAILURE PROTECTION FOR ETHERNET RING NETWORKS

(71) Applicant: Cisco Technology, Inc., San Jose, CA (US)

(72) Inventors: Srinivasa Rao Nalluri, Bangalore (IN); Ashok Hegde, Bangalore (IN); Robert E. Barton, Richmond (CA)

(73) Assignee: Cisco Technology, Inc., San Jose, CA (US)

(21) Appl. No.: 19/198,697

(22) Filed: May 5, 2025

(51) Int. Cl. H04L 12/437; H04L 45/00; H04L 45/28

(52) U.S. Cl. CPC H04L 12/437; H04L 45/22; H04L 45/28

(57) ABSTRACT

In one implementation, a device in a network maintains a link between the device and each of its neighbor nodes along a primary ring in the network. The device also maintains a link between the device and a particular node in the network that is not a neighbor of the device along the primary ring in the network. The device makes a determination that a second failure exists along the primary ring in the network. The device unblocks, based on the determination the link between the device and the particular node to allow traffic in the network to bypass the second failure.

### TECHNICAL FIELD

The present disclosure relates generally to computer networks, and, more particularly, to multi-failure protection for Ethernet ring networks.

### BACKGROUND

Operational Technology (OT) networks are typically used to automate processes, such as factories, buildings, etc. Increasingly, OT networks are making use of networking devices that form a ring topology. Indeed, it is now common to see many rings of OT networks connecting various other ring networks or endpoint such as sensors, input/output (I/O) devices, and the like, through the ring topology and back to the enterprise. In general, ring topologies afford additional resiliency to the network, in the case of link failure.

There are several Ethernet Ring Protection (ERP) protocols, such as Resilient Ethernet Protocol (REP), G.8032, Media Redundancy Protocol (MRP), and Device Level Ring (DLR), all of which add resilience when a node or link in the ring network fails. Most of these protocols also support sub-50 ms traffic convergence in the event of a failure. However, these protocols are limited to support traffic recovery in case there is single link or node failure in topology. This means that they are still susceptible to multiple failures, which could have significant repercussions, such as in the case of critical infrastructure (e.g., power utilities, etc.).

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example network;

FIG. 2 illustrates an example network device/node;

FIG. 3 illustrates an example network that includes a ring network;

FIGS. 4A-4D illustrate an example of a ring network recovering from multiple failures; and

FIG. 5 illustrates an example simplified procedure for multi-failure protection for a ring network.

### DESCRIPTION OF EXAMPLE EMBODIMENTS

### Overview

According to one or more embodiments of the disclosure, a device in a network maintains a link between the device and each of its neighbor nodes along a primary ring in the network. The device also maintains a link between the device and a particular node in the network that is not a neighbor of the device along the primary ring in the network. The device makes a determination that a second failure exists along the primary ring in the network. The device unblocks, based on the determination the link between the device and the particular node to allow traffic in the network to bypass the second failure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications, and others. Other types of networks, such as field area networks (FANs), neighborhood area networks (NANs), personal area networks (PANs), etc. may also make up the components of any given computer network.

In various embodiments, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or Powerline Communication networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Edge computing is a distributed approach of cloud implementation that acts as an intermediate layer from local networks (e.g., IoT networks) to the cloud (e.g., centralized and/or shared resources, as will be understood by those skilled in the art). That is, generally, edge computing entails using devices at the network edge to provide application services, including computation, networking, and storage, to the local nodes in the network, in contrast to cloud-based approaches that rely on remote data centers/cloud environments for the services. To this end, a edge node is a functional node that is deployed close to edge endpoints to provide computing, storage, and networking resources and services. Multiple edge nodes organized or configured together form a edge system, to implement a particular solution. Edge nodes and edge systems can have the same or complementary capabilities, in various implementations. That is, each individual edge node does not have to implement the entire spectrum of capabilities. Instead, the edge capabilities may be distributed across multiple edge nodes and systems, which may collaborate to help each other to provide the desired services. In other words, a edge system can include any number of virtualized services and/or data stores that are spread across the distributed edge nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:
1) Links are generally lossy, such that a Packet Delivery Rate/Ratio (PDR) can dramatically vary due to various sources of interferences, e.g., considerably affecting the bit error rate (BER);
2) Links are generally low bandwidth, such that control plane traffic must generally be bounded and negligible compared to the low rate data traffic;
3) There are a number of use cases that require specifying a set of link and node metrics, some of them being dynamic, thus requiring specific smoothing functions to avoid routing instability, considerably draining bandwidth and energy;
4) Constraint-routing may be required by some applications, e.g., to establish routing paths that will avoid non-encrypted links, nodes running low on energy, etc.;
5) Scale of the networks may become very large, e.g., on the order of several thousands to millions of nodes; and
6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

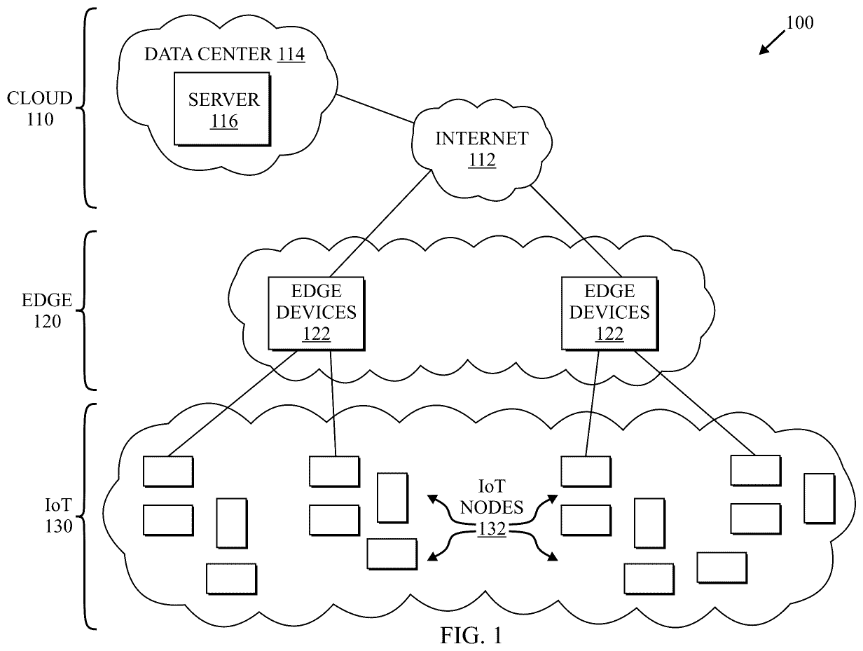

FIG. 1 is a schematic block diagram of a simplified example of a computer network 100 illustratively comprising nodes/devices at various levels of the network, interconnected by various methods of communication. For instance, the links may be wired links or shared media (e.g., wireless links, powerline communication links, etc.) where certain nodes, such as, e.g., routers, sensors, computers, etc., may be in communication with other devices, e.g., based on connectivity, distance, signal strength, current operational status, location, etc.

Specifically, as shown in computer network 100, three illustrative layers are shown: cloud layer 110, edge layer 120, and IoT device layer 130. Illustratively, the cloud layer 110 may comprise general connectivity via the Internet 112, and may contain one or more datacenters 114 with one or more centralized servers 116 or other devices, as will be appreciated by those skilled in the art. Within the edge layer 120, various edge nodes/devices 122 (e.g., with edge modules, described below) may execute various edge computing resources on network edge devices, as opposed to datacenter/cloud-based servers or on the endpoint nodes 132 themselves of the IoT device layer 130. For example, edge nodes/devices 122 may include edge routers and/or other networking devices that provide connectivity between cloud layer 110 and IoT device layer 130. Data packets (e.g., traffic and/or messages sent between the devices/nodes) may be exchanged among the nodes/devices of computer network 100 using predefined network communication protocols such as certain known wired protocols, wireless protocols, powerline communication protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, computer network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc..), powerline communication protocols, or other shared-media protocols where appropriate. In this context, a protocol consists of a set of rules defining how the nodes interact with each other.

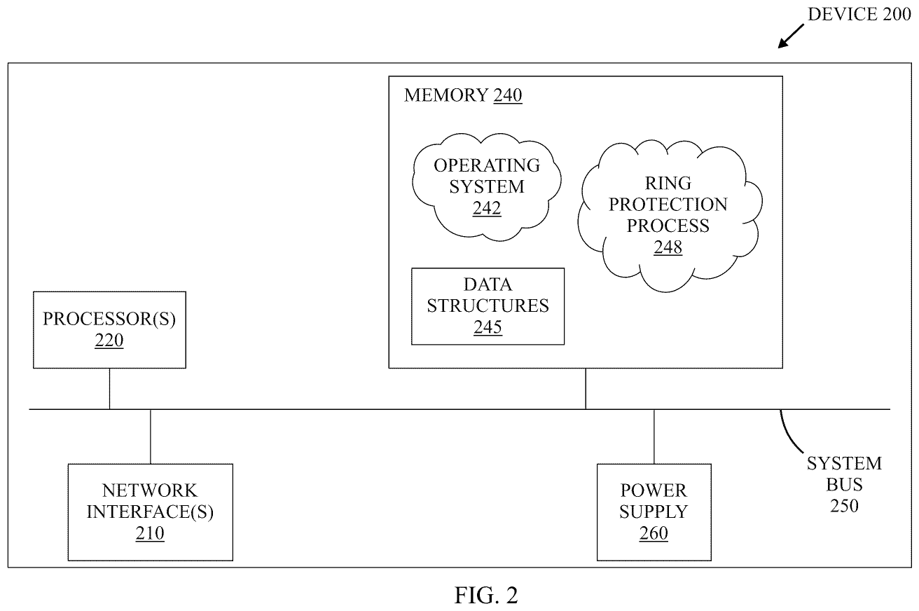

FIG. 2 is a schematic block diagram of an example node/device 200 (e.g., an apparatus) that may be used with one or more embodiments described herein. As shown, device 200 may comprise one or more of communication interfaces 210 (e.g., wired, wireless, etc.), a processor 220 (or multiple processors) coupled to communication interfaces 210, and a memory 240 interconnected by a system bus 250, as well as a power supply 260 (e.g., battery, plug-in, etc.). In various embodiments, node/device 200 may take the form of a networking device, such as a switch, router, or the like.

Communication interfaces 210 include the mechanical, electrical, and signaling circuitry for communicating data over a communication link. To this end, communication interfaces 210 may be configured to transmit and/or receive data using a variety of different communication protocols, such as Ethernet, TCP/IP, UDP, etc. Note that the device 200 may have multiple different types of communication interfaces 210, e.g., wireless and wired/physical connections, and that the view herein is merely for illustration.

The memory 240 comprises a plurality of storage locations that are addressable by processor 220 and communication interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by processor 220, functionally organizes the node by, inter alia, invoking network operations in support of software processors and/or services executing on the device. These software processors and/or services may comprise a ring protection process 248, as detailed below.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, ring protection process 248 may include computer executable instructions that, when executed by processor 220, cause device 200 to perform the techniques described herein. To do so, in some implementations, ring protection process 248 may utilize artificial intelligence (AI)/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, ring protection process 248 may use one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/machine learning techniques that ring protection process 248 may use include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, ring protection process 248 may also use one or more generative AI/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, generative adversarial networks (GANs), large language models (LLMs) and other foundation models, diffusion models, transformer models, and the like.

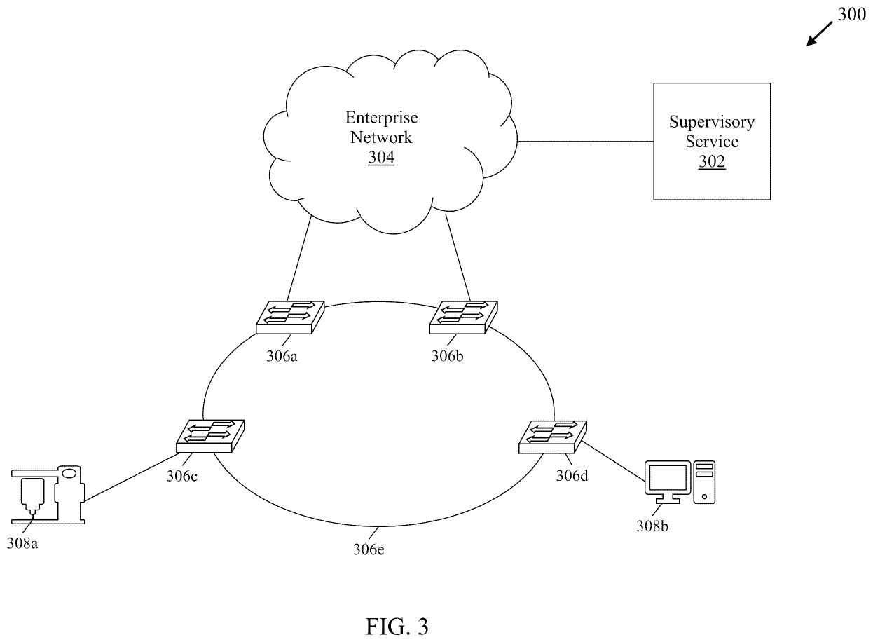

As noted above, it is common in many Operational Technology (OT) networks and Industrial IoT (IIoT) networks to include networking devices (e.g., switches, routers, etc.) arranged in a ring topology, to connect to other rings and/or endpoints such as sensors, input/output (I/O) devices, and the like, thereby providing connectivity back to the enterprise. FIG. 3 illustrates an example network 300 that includes such a ring, according to various implementations.

More specifically, as shown in FIG. 3, network 300 may comprise any number of networking devices 306, such as networking devices 306a-306e (e.g., Ethernet switches, etc.), which provide connectivity between endpoints 308, such as endpoints 308a-308b, and an enterprise network 304. For instance, endpoints 308a-308b may take the form of sensors, actuators, moving nodes (e.g., vehicles, mine carts, etc.), human-machine-interfaces, controllers, or the like.

In various implementations, networking devices 306a-306e may form one or more rings (e.g., ring topologies). For instance, networking devices 306a-306e may form a ring network.

Network 300 may also include a supervisory service 302 that provides supervisory control over the networking devices in network 300, such as 306a-306e. An example of such a supervisory service is Cisco Digital Network Architecture (Cisco DNA) by Cisco Systems, Inc., a Supervisory Control and Data Acquisition (SCADA) system, or the like. Such supervisory function may include, for example, any or all of the following, among others:
Device Onboarding: here, supervisory service 302 may be responsible for overseeing the onboarding of any new devices to the network, such as assigning them to security groups, cataloging the new device, etc.
Implementing Security Policies: supervisory service 302 may also be responsible for specifying security policies for network 300, such as by preventing a certain endpoint from communicating with another endpoint, etc.
Network Monitoring: supervisory service 302 may also receive telemetry data collected from network 300, allowing supervisory service 302 to assess and report on the health of network 300.
Device Configuration: supervisory service 302 may also configure the networking devices in network 300, such as by pushing software updates to networking devices 306a-306e.

As noted above, ring networks are ubiquitous in many settings including, but not limited to, power utilities, factories and other industrial networks, certain backhaul networks, and the like. The primary advantage of ring networks is that they afford additional resiliency to the network, in the case of link failure. For instance, if a particular link experiences a failure, traffic can still reach its destination by flowing in the opposite direction in the ring.

There are several Ethernet Ring Protection (ERP) protocols, such as Resilient Ethernet Protocol (REP), G.8032, Media Redundancy Protocol (MRP), and Device Level Ring (DLR), all of which add resilience when a node or link in the ring network fails. Most of these protocols also support sub-50 ms traffic convergence in the event of a failure. However, these protocols are limited to support traffic recovery in case there is single link or node failure in topology. This means that they are still susceptible to multiple failures (e.g., two or more links fail at the same time, etc.), which could have significant repercussions, such as in the case of critical infrastructure (e.g., power utilities, etc.).

### Multi-Failure Protection for Ethernet Ring Networks

The techniques herein provide for multi-failure protection for ring networks, such as Ethernet ring networks. In some aspects, the techniques herein leverage machine learning/artificial intelligence (e.g., a decision tree or other suitable model), to allow the ring to choose a corrective action for a failure scenario.

Illustratively, the techniques described herein may be performed by hardware, software, and/or firmware, such as in accordance with ring protection process 248, which may include computer executable instructions executed by the processor 220 (or independent processor of communication interfaces 210) to perform functions relating to the techniques described herein.

Specifically, according to various embodiments, a device in a network maintains a link between the device and each of its neighbor nodes along a primary ring in the network. The device also maintains a link between the device and a particular node in the network that is not a neighbor of the device along the primary ring in the network. The device makes a determination that a second failure exists along the primary ring in the network. The device unblocks, based on the determination the link between the device and the particular node to allow traffic in the network to bypass the second failure.

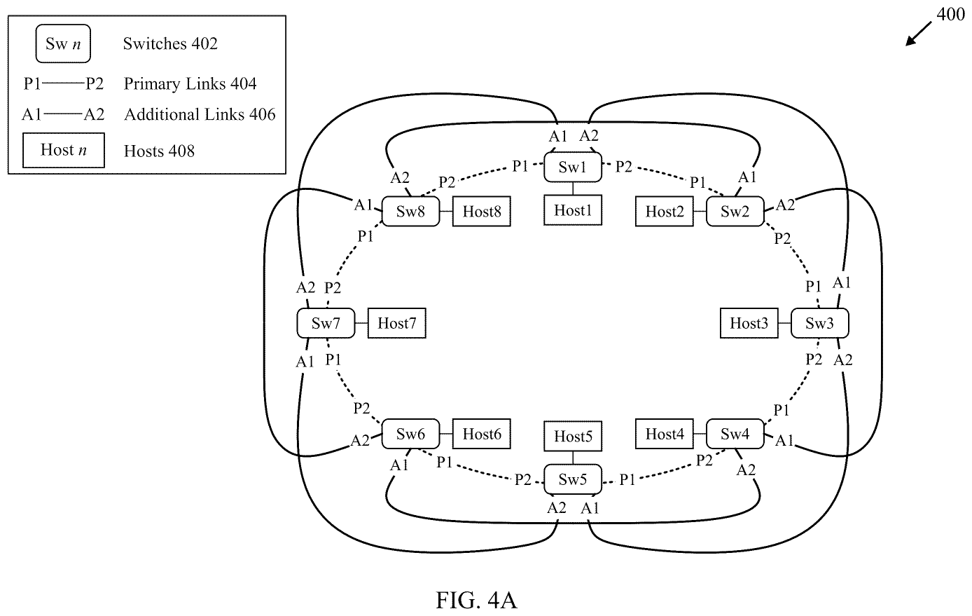

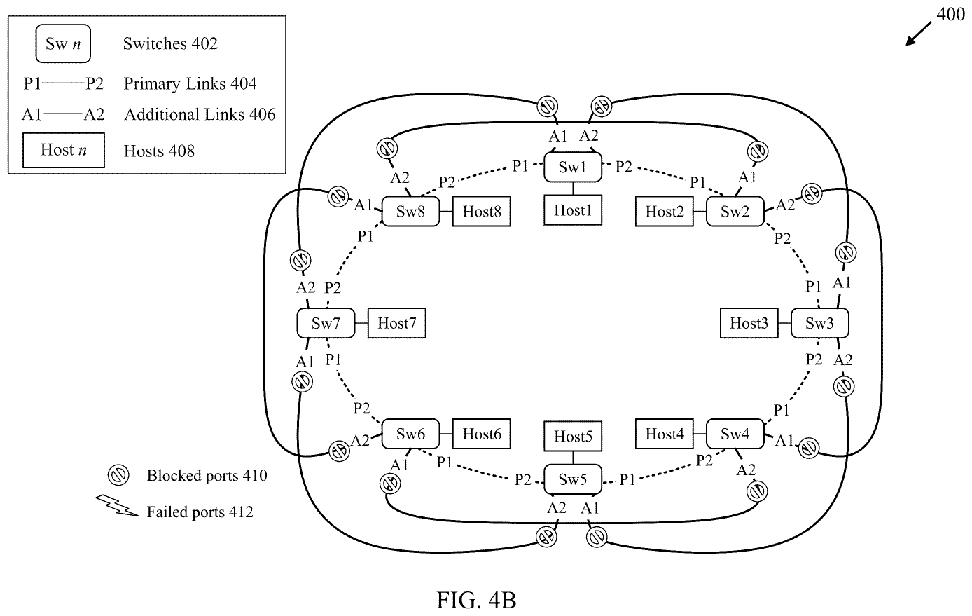

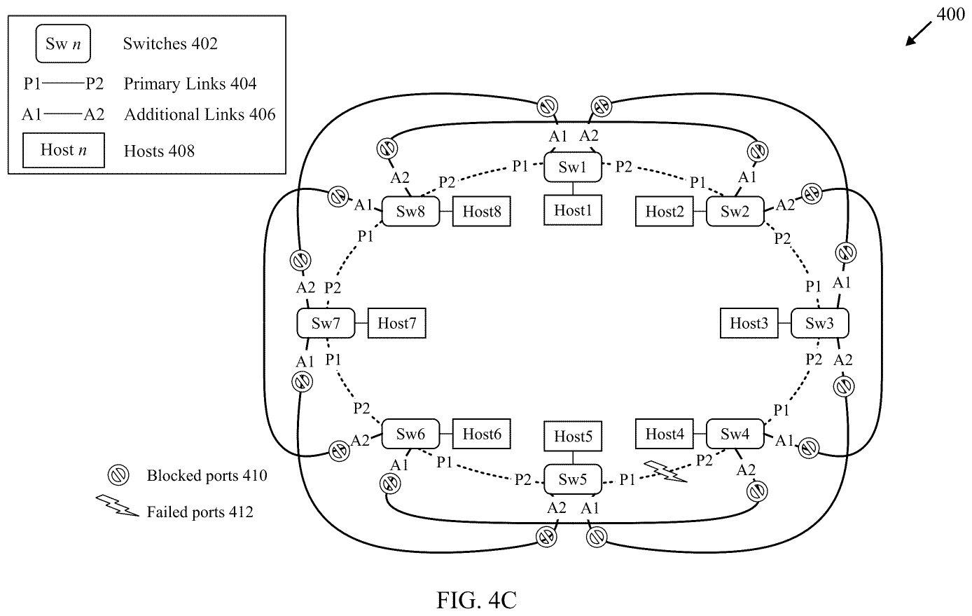

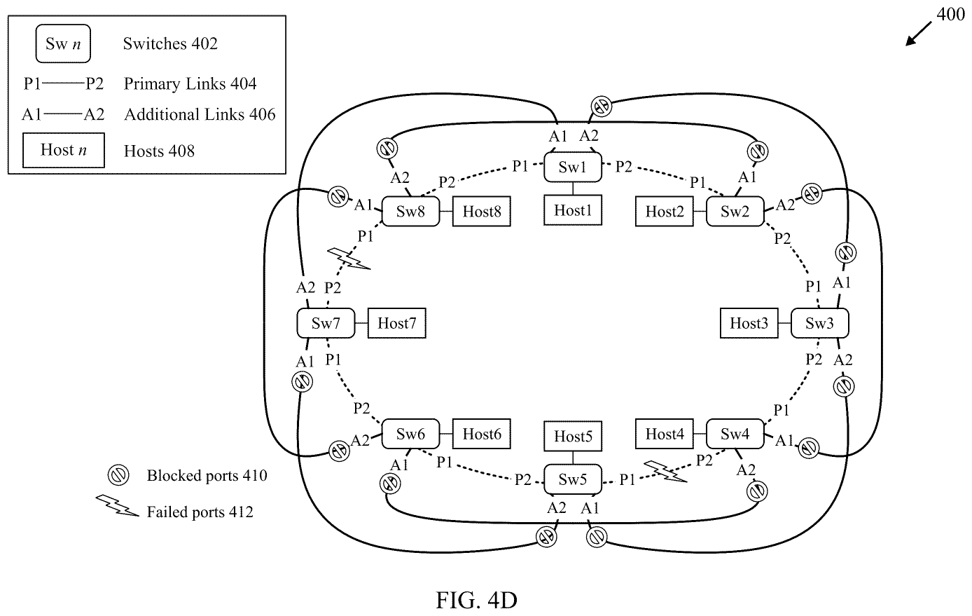

Operationally, FIGS. 4A-4D illustrate an example of a ring network 400 recovering from multiple failures, according to various implementations. As shown in FIG. 4A, ring network 400 may include switches 402 that are interconnected with one another, such as switches Sw1-Sw8. There may also be any number of the hosts 408, each of which may be connected to a corresponding one of switches 402 (e.g., sensors, actuators, computing devices, etc.). Preferably, switches 402 are Ethernet switches, although the techniques herein could also apply to other types of ring networks, as well. As would be appreciated, while eight switches are shown, this configuration is illustrative only and ring network 400 may include any number of switches or other networking devices.

To protect against a singular link failure in ring network 400, ring network 400 may include primary links 404, thereby forming a primary ring among switches 402. More specifically, each of switches 402 may have two primary ports, P1 and P2, that are wired to opposing neighbors of that switch. For instance, port P1 of switch Sw1 may be wired to port P2 of switch Sw8 and port P2 of switch Sw1 may be wired to port P1 of switch Sw2. In doing so, each of switches 402 is reachable by any of the other switches in ring network 400.

According to various implementations, the techniques herein also introduce additional links 406 that further interconnect switches 402. For instance, in some implementations, each of switches 402 may use two alternative ports, denoted A1 and A2, to connect that switch to other switches in ring network 400 that are not its direct neighbors. For instance, port A1 of switch Sw1 may be connected to port A2 of switch Sw7 and port A2 of Sw1 may be connected to port A1 of Sw3. Consequently, each of switches 402 is connected to its two neighbors, as well as two additional switches in ring network 400.

Primary links 404 provide failure protection against a single point of failure, such as one of primary links 404 or switches 402 failing. In such a case, failure recovery may simply entail redirecting the traffic in ring network 400 away from the failure (e.g., by redirecting at least some of the traffic in the opposite direction in ring network 400). Additional links 406 then provide even more protection to ring network 400, as in the case of multiple failures occurring at the same time. Indeed, additional links 406 provide even further alternative paths in ring network 400, should multiple failures occur simultaneously.

As shown in FIG. 4B, in its initial state, ring network 400 may be configured with blocked ports 410 (e.g., blocked links) from amongst primary links 404 and additional links 406. Here, blocked ports 410 may include one port P1 and one port P2 from among primary links 404 so as to disable exactly one of primary links 404. Doing so avoids a Layer-2 loop within ring network 400. In addition, blocked ports 410 may also initially include all of additional links 406.

Through an initial protocol message exchange, switches 402 may identify and maintain identity information for their neighbors, as well as for the next switches after that (e.g., for both their next hop and 2-hop neighbors). Such information may take the form of identifiers for those switches, such as their Media Access Control (MAC) addresses, configurable numbers that are unique in ring network 400, or any other suitable identifiers.

In various implementations, each of switches 402 may also maintain a link mapping database that indicates all possible alternate paths for that switch. For instance, Sw1 may maintain a mapping as follows:
Sw1-P1→Sw8-P2
Sw1-P2→Sw2-P1
Sw1-A1→Sw7-A2
Sw1-A2→Sw3-A1

In another example, Sw5 may maintain a mapping as follows:
Sw5-P1→Sw4-P2
Sw5-P2→Sw6-P1
Sw5-A1→Sw3-A2
Sw5-A2→Sw7-A1

Now, consider the case shown in FIG. 4C in which there is a failure in primary links 404, such as the primary link between switch Sw4 and switch Sw5. Such failures are denoted in FIGS. 4A-4D as failed ports 412. In such a case, the ring protocol in use within ring network 400 may detect the failure and react to the failure by unblocking the blocked primary link between switch Sw1 and switch Sw2, allowing ring network 400 to converge quickly. In various implementations, this could be achieved using REP, MRP, G.8032, or another suitable ring protection protocol as desired.

In this state all hosts 408 can still reach other hosts without any loop in network. For instance, assume that Host6 connected to switch Sw6 is to communicate with Host3 that is connected to switch Sw3. Typically, it would do so by sending its traffic along the path Host6→Sw6→Sw5→Sw4→Sw3→Host3. However, the link between switch Sw5 and switch Sw4 has failed. By unblocking the primary link between switch Sw1 and switch Sw2, Host6 can instead send its traffic to Host3 via the path Host6→Sw6→Sw7 →Sw8→Sw1→Sw2→Sw3→Host3, thereby avoiding the failed link.

Continuing this, consider now the case shown in FIG. 4D in which there are two failures: the link between switch Sw7 and switch Sw8 and the link between switch Sw4 and switch Sw5. In this case, the failed ports 412 will result in the isolation of Host8, Host1, Host2, Host3 and Host4 from Host5, Host6 and Host7 along the primary ring. By unblocking the link between switch Sw7 and switch Sw1, as well as the primary link between switch Sw1 and switch Sw2, all of hosts 408 will be able to reach any of the other ones via ring network 400.

According to various implementations, to facilitate this behavior, ring network 400 may make use of a decision tree configured to choose a restoration action for a given set of one or more failures. Typically, only one of switches 402 may need to compute the decision tree (such as the switch at the edge of ring network 400). The decision tree will allow ring network 400 to compute all link failure combinations and take a corrective action if these occur. For example, the computing switch may run a Monte Carlo simulation to create a Monte Carlo Decision Tree (MCDT) with a suggested action to take if any two combinations of links fail simultaneously. In turn, the switch that computes the decision tree may disseminate it amongst switches 402, so that each switch is aware of the actions that it should take in view of a particular failure or pair of failures.

In further implementations, any or all of switches 402 may compute the decision tree. Or, alternatively, another computing device (e.g., a supervisory server, another node, etc.) may compute the decision tree. In yet another implementation, any other suitable form of heuristics, rules, or AI/ML model may take the place of the decision tree, so long as there is a mapping between failure scenarios and corrective actions.

It is important to note that each of switches 402 in ring network 400 is aware of the overall topology as it changes, thanks to the networking protocol used in ring network 400. Thus, from the perspective of each of switches 402, as the topology of ring network 400 changes, that switch only needs to reference its decision tree (or other mapping), to decide the best course of action, effectively unblocking the correct link or links and restoring ring network 400 back to its full functionality.

For example, assume that switch Sw7 notices that there is a failure in its link with switch Sw8, concurrent with the failure between switch Sw4 and switch Sw5. All participating switches may notice such a failure. In response, the switches may consult their respective decision trees that state that the best course of action would be for switch Sw7 to unblock its A2 port and for switch Sw1 to unblock its A1 port, thereby unblocking the additional link between switch Sw7 and switch Sw1.

In some implementations, switch Sw7, switch Sw8, and/or any other switch may mark the failure of the link between switch Sw7 and switch Sw8 as a second failure within ring network 400, with the failure of the link between switch Sw4 and switch Sw5 being the first failure. In instances in which a switch marks a second failure in ring network 400, it may initiate a Layer-2 forwarding database flush within ring network 400 followed by generation of protocol messages that indicate the second failed link.

The other ones of switches 402 in ring network 400 may then perform a Layer-2 forwarding flush and mark the state of ring network 400 as being in a second failure state. Thus, when a switch receives a second failure message, it may assess the second failure and, if applicable, unblock its local additional link towards unblocked peer additional link. In this state of ring network 400, despite a dual failure, each of hosts 408 can reach the other hosts in ring network 400.

As would be appreciated, further implementations may extend this approach to protect against even more simultaneous failures in ring network 400 by configuring ring network 400 with even further additional links. In such a case, the decision tree or other mapping between failure scenarios and corrective actions may be configured to take these links into account, as well.

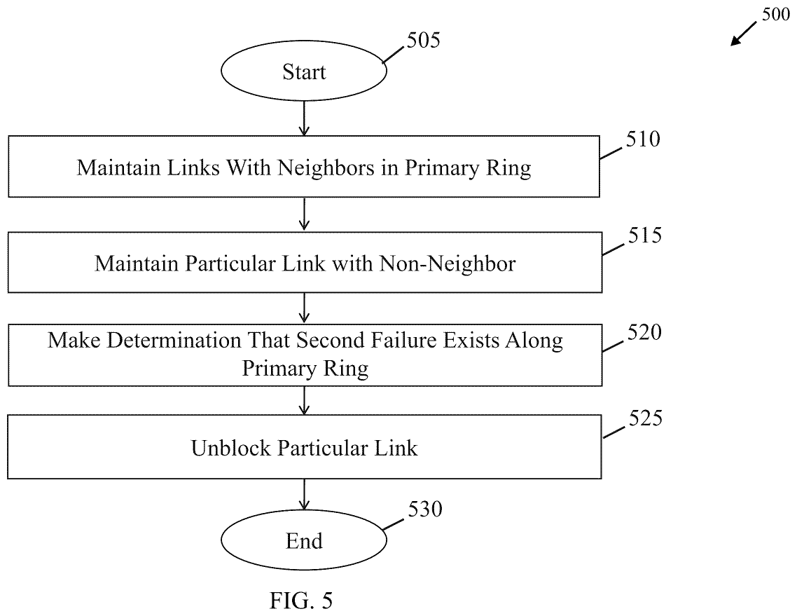

FIG. 5 illustrates an example simplified procedure for multi-failure protection for a ring network, in accordance with one or more embodiments described herein. In various embodiments, a non-generic, specifically configured networking device (e.g., device 200) may perform procedure 500 by executing stored instructions (e.g., ring protection process 248). For instance, a particular networking device, such as an Ethernet switch, etc., may perform procedure 500. The procedure 500 may start at step 505, and continues to step 510, where, as described in greater detail above, the device maintains a link between the device and each of its neighbor nodes along a primary ring in the network. This may entail, for instance, maintaining a physical or wireless link between the device and its neighbors in the primary ring. In addition, the device may also control whether a port associated with any of those links is in a blocked or unblocked state at any given time.

At step 515, as detailed above, the device maintains a link between the device and a particular node in the network that is not a neighbor of the device along the primary ring in the network. Similar to step 510, this may entail, for instance, maintaining a physical or wireless link between the device and one of its non-neighbors along the primary ring. In addition, the device may also control whether a port associated with that link is in a blocked or unblocked state at any given time.

At step 520, the device makes a determination that a second failure exists along the primary ring in the network, as described in greater detail above. In various implementations, a first failure exists simultaneously along the primary ring in the network with the second failure. In such a case, the network may recover from the first failure by unblocking a link along the primary ring in the network. In addition, the device may receive a notification of the first failure and base its determination that the second failure exists in part on the notification. In some instances, the second failure is associated with a link between the device and one of its neighbor nodes along the primary ring in the network. In one implementation, the device may also notify one or more nodes along the primary ring in the network as to the second failure. In further implementations, the device may also initiate, based on the determination, a flush of forwarding information by one or more nodes in the network.

At step 525, as detailed above, the device unblocks, based on the determination the link between the device and the particular node to allow traffic in the network to bypass the second failure. In various implementations, the device may use a decision tree to determine that it should unblock the link between the device and the particular node to allow traffic in the network to bypass the second failure. In some cases, the device may compute the decision tree itself. In other cases, the device may receive the decision tree.

Procedure 500 then ends at step 530.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments for dual failure protection for ring networks, such as Ethernet ring networks, it is to be understood that various other adaptations and modifications may be made within the intent and scope of the embodiments herein. For instance, while the techniques herein are primarily described with respect to an Ethernet ring, the techniques herein are not limited as such and can be applied to any form of communication network that uses a ring topology.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method comprising:
maintaining, by a device in a network, a link between the device and each of its neighbor nodes along a primary ring in the network;
maintaining, by the device, a link between the device and a particular node in the network that is not a neighbor of the device along the primary ring in the network;
making, by the device, a determination that a second failure exists along the primary ring in the network; and
unblocking, by the device and based on the determination, the link between the device and the particular node to allow traffic in the network to bypass the second failure.

2. The method as in claim 1, wherein a first failure exists simultaneously along the primary ring in the network with the second failure.

3. The method as in claim 2, wherein the network recovers from the first failure by unblocking a link along the primary ring in the network.

4. The method as in claim 2, further comprising:
receiving, at the device, a notification of the first failure, wherein the determination that the second failure exists is based in part on the notification.

5. The method as in claim 1, further comprising:
using, by the device, a decision tree to determine that it should unblock the link between the device and the particular node to allow traffic in the network to bypass the second failure.

6. The method as in claim 5, further comprising:
receiving the decision tree at the device.

7. The method as in claim 1, wherein the second failure is associated with a link between the device and one of its neighbor nodes along the primary ring in the network.

8. The method as in claim 1, further comprising:
notifying, by the device, one or more nodes along the primary ring in the network as to the second failure.

9. The method as in claim 1, further comprising:
initiating, by the device and based on the determination, a flush of forwarding information by one or more nodes in the network.

10. The method as in claim 1, wherein the device is an Ethernet switch.

11. An apparatus, comprising:
one or more interfaces to communicate in a network;
a processor coupled to the one or more interfaces and configured to execute one or more processes; and
a memory configured to store a process that is executable by the processor, the process when executed configured to:
maintain a link between the apparatus and each of its neighbor nodes along a primary ring in the network;
maintain a link between the apparatus and a particular node in the network that is not a neighbor of the apparatus along the primary ring in the network;
make a determination that a second failure exists along the primary ring in the network; and
unblock, based on the determination, the link between the apparatus and the particular node to allow traffic in the network to bypass the second failure.

12. The apparatus as in claim 11, wherein a first failure exists simultaneously along the primary ring in the network with the second failure.

13. The apparatus as in claim 12, wherein the network recovers from the first failure by unblocking a link along the primary ring in the network.

14. The apparatus as in claim 12, wherein the process when executed is further configured to:
receive a notification of the first failure, wherein the determination that the second failure exists is based in part on the notification.

15. The apparatus as in claim 11, wherein the process when executed is further configured to:
use a decision tree to determine that the apparatus should unblock the link between the apparatus and the particular node to allow traffic in the network to bypass the second failure.

16. The apparatus as in claim 15, wherein the process when executed is further configured to:
receive the decision tree at the apparatus.

17. The apparatus as in claim 11, wherein the second failure is associated with a link between the apparatus and one of its neighbor nodes along the primary ring in the network.

18. The apparatus as in claim 11, wherein the process when executed is further configured to:
notify one or more nodes along the primary ring in the network as to the second failure.

19. The apparatus as in claim 11, wherein the process when executed is further configured to:
initiate, based on the determination, a flush of forwarding information by one or more nodes in the network.

20. A tangible, non-transitory, computer-readable medium storing program instructions that cause a device in a network to execute a process comprising:
maintaining, by the device, a link between the device and each of its neighbor nodes along a primary ring in the network;
maintaining, by the device, a link between the device and a particular node in the network that is not a neighbor of the device along the primary ring in the network;
making, by the device, a determination that a second failure exists along the primary ring in the network; and
unblocking, by the device and based on the determination, the link between the device and the particular node to allow traffic in the network to bypass the second failure.
